(19) United States
(12) Patent Application Publication
(10) Pub. No.: US 2007/0006298 A1
(43) Pub. Date: Jan. 4, 2007

(54) Controlling access to a workstation system via wireless communication

(76) Inventors: Christopher Gregory Malone, Loomis, CA (US); Thane Michael Larson, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/170,920

(22) Filed: Jun. 30, 2005

(51) Int. Cl. G06F 12/14

(52) U.S. Cl. 726/17

(57) ABSTRACT

A workstation system includes at least one workstation including a RFID transceiver, a RFID transponder tag, and an access manager. The RFID transponder tag includes a memory for storing a personnel identifier and an access identifier. The access manager is configured for controlling access to the at least one workstation via wireless communication between the RFID transceiver and the RFID transponder regarding the access identifier and the personnel identifier.

### BACKGROUND

Computers and computer networks have become a gateway to highly valuable corporate or personal resources, including financial information, trade secrets, personal information, strategic plans, etc. Unfortunately, many unscrupulous competitors, hackers, and/or mischievous employees aim to steal, corrupt, or misuse these computer resources. In this electronic world, physical boundaries such as walls and doors are no longer adequate to maintain security. Consequently, virtually all computers require a password to be typed in at the computer or workstation to obtain access to the computer resources. However, even alphanumeric passwords often cannot protect the computer resources.

Biometrics is one example of a recently developed security mechanism. Biometric devices enable access by recognizing some unique aspect of a person, such as their fingerprint, retinal pattern in their eye, a sound of their voice, etc. Accordingly, some computer systems require authentication of a person's identity via a biometric device prior to granting access to the computer.

Other computer systems require a card with a magnetic strip to be swiped at a card reader associated with the computer system before granting access. Unfortunately, maintaining biometric-based access requires a vast database of biometric data and is expensive to implement on a large scale basis. Card reader systems also require each user to have a card, which adds administrative burdens, and each computer must have a card reader, which adds hardware costs and can be unsightly.

In addition to computer systems, other types of devices sometimes require secured access. For example, access to a point-of-sale terminal such as an electronic cash register, is conventionally protected with a physical key or electronic card inserted into the terminal. However, this point-of-sale terminal is left unprotected if the authorized user temporarily steps away from the terminal without removing the key or card. Other types of devices face similar protection problems include operating stations of machinery, such as presses, which pose physical dangers when left unprotected by a temporary absence after secure access has been granted.

For these reasons, administrators of computers and computer resources, as well as administrators of other types of workstations, still face challenges in effectively controlling access to those resources.

### SUMMARY

Embodiments of present invention are directed to a wireless access for a workstation system. In one embodiment, a workstation system comprises at least one workstation including a RFID transceiver, a RFID transponder tag, and an access manager. The RFID transponder tag includes a memory for storing a personnel identifier and an access identifier. The access manager is configured to control access to the at least one workstation via wireless communication between the RFID transceiver and the RFID transponder tag regarding the access identifier and the personnel identifier.

### BRIEF DESCRIPTION OF THE DRAWINGS

FIG. 1 is a plan view schematically illustrating a RFID system, according to an embodiment of the invention.

FIG. 2 is a block diagram of a transponder of a RFID system, according to an embodiment of the invention.

FIG. 3 illustrates a workstation system, according to an embodiment of the invention.

FIG. 4 is a block diagram schematic illustrating a RFID transponder tag, according to an embodiment of the invention.

FIG. 5 is a block diagram of an access monitor, according to an embodiment of the invention.

FIG. 6 is a flow diagram of a method of controlling access to a workstation system, according to an embodiment of the invention.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following Detailed Description, therefore, is not to be taken in a limiting sense, and the scope of the present invention is defined by the appended claims.

Embodiments of the invention are directed to controlling access to a workstation system via wireless communication. In one embodiment, a tag or badge associated with a person stores information regarding the person and information regarding authorization to access the workstation system for that person. The information is communicated from the tag to an access manager of the workstation system via a wireless communication pathway between the tag and the manager to enable controlling access to the workstation system.

A workstation comprises a station or device at which an individual operates or uses the station or device and the presence of the individual is required for use of the device. In one embodiment, the workstation system comprises a computer system including at least one computer as the workstation. In another embodiment, the workstation system comprises a terminal system including at least one point-of-sale terminal as the workstation. In another embodiment, the workstation system comprises an operating station system for machinery including at least one operating station as the workstation. Those skilled in the art will recognize other stations or devices considered to be workstations as defined in this application.

In one embodiment, the person comprises an employee of an organization. In other embodiments, the person comprises any individual or individuals for which access is to be granted, such as a guest, family member, vendor, auditor, supervisor, administrator, police officer, paramedic, etc. One or more of these individuals are referred to as personnel throughout this description.

Wireless communication greatly simplifies controlling access to a workstation system because it provides a communication pathway independent of other connections and pathways forming the workstation system/network. In one embodiment, a RFID (radio frequency identification) transponder is disposed on a tag, such as a personnel tag or badge, which then communicates via radio frequency signals with a RFID transceiver disposed within or on one or more workstations of the workstation system. Each RFID transponder stores information about one or more parameters of the individual (associated with the tag) to insure that the right individual, such as an employee, is accessing the right workstation. This access verification is performed electronically, instead of or in addition to a physical access mechanism, such as a locked room or biometric access device. This access verification also is performed, in some instances, as an additional security layer beyond conventional password measures.

In one embodiment, an access identifier associated with an individual is stored in RFID transponder tag and identifies the type of access privileges for that individual based on the individual's status, such as user, technician, administrator, etc. In one embodiment, the access identifier also identifies the level of access privileges, such as whether the individual gets access to a single workstation, a local workstation system, a network, and/or a particular location of workstations, etc. This information regarding an individual is compared to database (of employee or personnel information and access information) of an access manager of the workstation system to determine whether access will be granted and which type and/or level of access is granted.

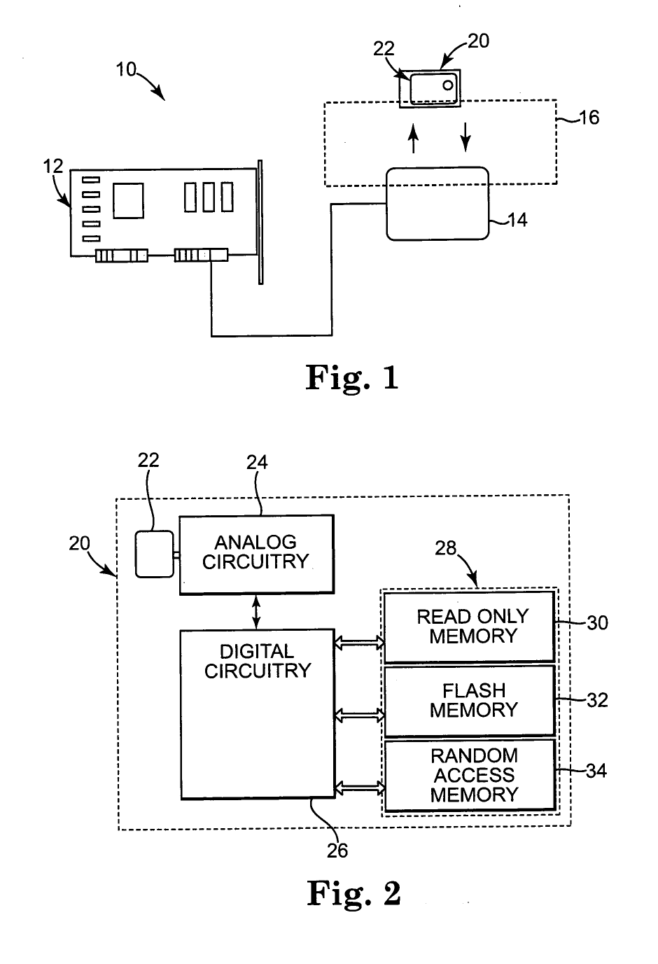

Accordingly, embodiments of the invention enable new ways of controlling access to workstation systems via wireless communication pathways. Embodiments of the invention are described and illustrated in detail in association with FIGS. 1-6.

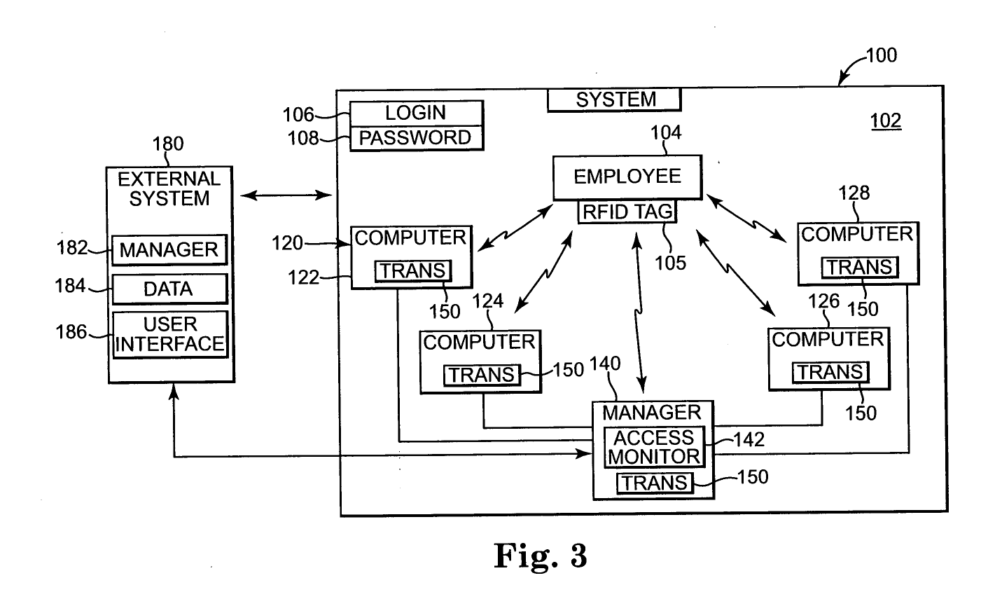

In one embodiment of the invention, a wireless communication pathway is established via radio frequency waves, and in particular via a radio frequency identification (RFID) system. Accordingly, one exemplary embodiment of a RFID system is described and illustrated in association with FIGS. 1-2 as a foundation for a description of wireless monitoring of electronics systems, as described and illustrated in association with FIGS. 3-6.

FIG. 1 illustrates radio frequency identification (RFID) system 10. RFID system 10 includes transceiver 12 and transponder 20. Transceiver 12 includes transceiver antenna 14. Transponder 20 includes transponder antenna 22. Signals generated by transceiver antenna 14 and by transponder antenna 22 are transferred through medium interface 16.

Transceiver 12 of RFID system 10 is configured to communicate with transponder 20. In one embodiment, transceiver 12 includes a microprocessor, and in another embodiment, transceiver 12 is coupled to a host system that includes a microprocessor. In one embodiment, transceiver antenna 14 is integrated within a single transceiver device. In one embodiment, transceiver 12 includes a separate transceiver circuit device and a separate transceiver antenna 14. Transceiver antenna 14 emits radio frequency signals that are transmitted through medium 16 to activate transponder 20. After activating transponder 20, transceiver 12 reads and writes data to and from transponder 20. Transceiver antenna 14 and transponder antenna 22 are the conduits between transceiver 12 and transponder 20, and communicate radio frequency signals through medium interface 16.

In some embodiments, medium interface 16 is air, and in other embodiments medium interface 16 includes air and other materials. Transceiver antenna 14 and transponder antenna 22 can be of a variety of shapes and sizes, dependent upon the anticipated distance separating them, the type of medium 16 that is between antennas 14 and 22, and on other factors.

Transceiver 12 typically performs a variety of functions in controlling communication with transponder 20. In one case, transceiver 12 emits output signals from transceiver antenna 14, thereby establishing an electromagnetic zone for some distance adjacent antenna 14. When transponder 20 passes through the electromagnetic zone established by transceiver antenna 14, transponder 20 detects an activation signal from transceiver 12. Transponder 20 typically has integrated circuits that include data that is encoded in memory. Once transponder 20 is activated with the activation signal, transceiver 12 decodes data that is encoded in transponder 20. For instance, in one embodiment transceiver 12 performs signal conditioning, parody error checking and correction.

Typically, transceiver 12 emits radio waves in ranges from a few millimeters up to hundreds of feet or more, depending on its output power and upon the radio frequency used. In one case, transceiver 12 is integrated in a circuit board card that is then coupled to a host computer, which processes the received data and controls some of the communication with transponder 20.

FIG. 2 illustrates one embodiment of transponder 20. In one case, transponder 20 includes transponder antenna 22, analog circuitry 24, digital circuitry 26, and memory 28. In various embodiments, memory 28 can include read only memory (ROM) 30, flash memory 32, and/or random access memory (RAM) 34.

Transponder 20 comes in a variety of shapes and sizes for use in a variety of applications. In one embodiment, transponder 20 is a tag, thin card, or badge. In one embodiment, the transponder 20 is adhesively securable as a tape to an identification badge.

In some embodiments, transponder 20 includes one or more types of memory 28. For example, in some embodiments memory 28 includes ROM 30 to accommodate security data and operating system instructions that are employed in conjunction with analog circuitry 24 and digital circuitry 26 to control the flow of data within transponder 20. In other embodiments, memory 28 includes RAM 34 to facilitate temporary data storage during a time period when transceiver 12 is interrogating transponder 20 for a response. In other embodiments, memory 28 includes flash memory 32 to store data in transponder 20 that is non-volatile in order to ensure that the data is retained when transponder 20 is in a quiescent or power saving state. In some embodiments, memory 28 includes other types of non-volatile programmable memory, such as programmable read-only memory (PROM), erasable programmable read-only memory (EPROM), and electrically erasable programmable read-only memory (EEPROM). Any one of memory types ROM 30, flash memory 32 (or other non-volatile programmable memory), or RAM 34 can be used, or any combination thereof can be used.

In one embodiment, transponder 20 is an active transponder device. An active transponder is powered by an internal energy source, such as a battery configured within analog circuitry 24. Such active transponders are typically “read/write,” which means data stored within memory 28 of transponder 20 can be rewritten and/or modified. An active transponder can also be powered from an existing source in another electronic device. For example, where transponder 20 is an active transponder coupled within a computer system, the power supply within the computer system supplies power to the transponder.

In one embodiment, transponder 20 is a passive transponder device. Passive transponders operate without a separate internal power source and obtain operating power from transceiver 12. Rather than having a battery within analog circuitry 24, for example, passive tags instead can use a strongly capacitive circuit and a charge pump within analog circuitry 24. The capacitive circuit and charge pump are configured to receive radio frequency energy from transceiver 12 and store it for use within transponder 20, for example, to control digital circuit 26 and memory 28.

Since active transponders accommodate an internal battery, they are typically larger in size than passive transponders. Memory size within an active transponder varies, but can be fairly significant with some systems operating, for example, with up to a megabyte or more of memory. Active transponders also typically have a longer ready range such that transceiver 12 and transponder 20 are typically placed apart at greater distances than in the case of passive transponders. In the same way, passive transponders typically have shorter read ranges, but are typically much smaller and lighter than active transponders and are typically less expensive.

In addition to including a battery for active transponders or capacitive circuit and charge pump for passive transponders, analog circuitry 24 typically include interface circuits for data transfer between transponder antenna 22 and digital circuitry 26. Digital circuitry 26 in turn typically includes control logic, security logic, and internal logic or microprocessor capabilities. This control logic controls the flow of data to and from memory 28.

Accordingly, transceiver 12 and transponder 20 together establish a robust wireless communication pathway or network adaptable to a variety of environments.

According to one embodiment of the invention, transceiver 12 and one or more transponders 20 are arranged within a workstation system or network system to enable controlling access to the workstation system via wireless communication. FIG. 3 is a block diagram of computer system 100 including one such access control mechanism, according to one embodiment of the invention.

As shown in FIG. 3, computer system 100 comprises access area 102, RFID transponder tag 105, login module 106 with password function 108, manager 140 with access monitor 142, and array 120 of computers (or computer resources) 122-128. Each computer 122-128 of array 120 also comprises RFID transceiver 150. In one embodiment, manager 140 also comprises a transceiver 150 while in other embodiments, manager 140 does not include a transceiver 150. Transceiver 150 has substantially the same features and attributes of transceiver 12, and transponder of RFID transponder tag 105 has substantially the same features and attributes as transponder 20, as previously described and illustrated in association with FIGS. 1-2.

In one embodiment, array 120 of computers 122-128 of system 100 is replaced with one or more workstations of another type, such as a point-of-sale terminal, machinery operating station, etc that include transceiver 150. In other words, a workstation of system 100 comprises a station or device at which an individual operates or uses the station or device and the presence of the individual is required for use of the device. In another embodiment, system 100 comprises a combination of different types of workstations, such as a group including at least one computer and at least one point-of-sale terminal. In still another embodiment, one or more computers 122-128 is a laptop computer, desktop computer, server, and/or a computer resource such as a peripheral, including but not limited to a printer, a digital sender, a fax machine, etc. For purposes of illustration, system 100 will be described as a computer system throughout FIGS. 3-6 although computer system can comprise any one of the types of above-described workstation systems.

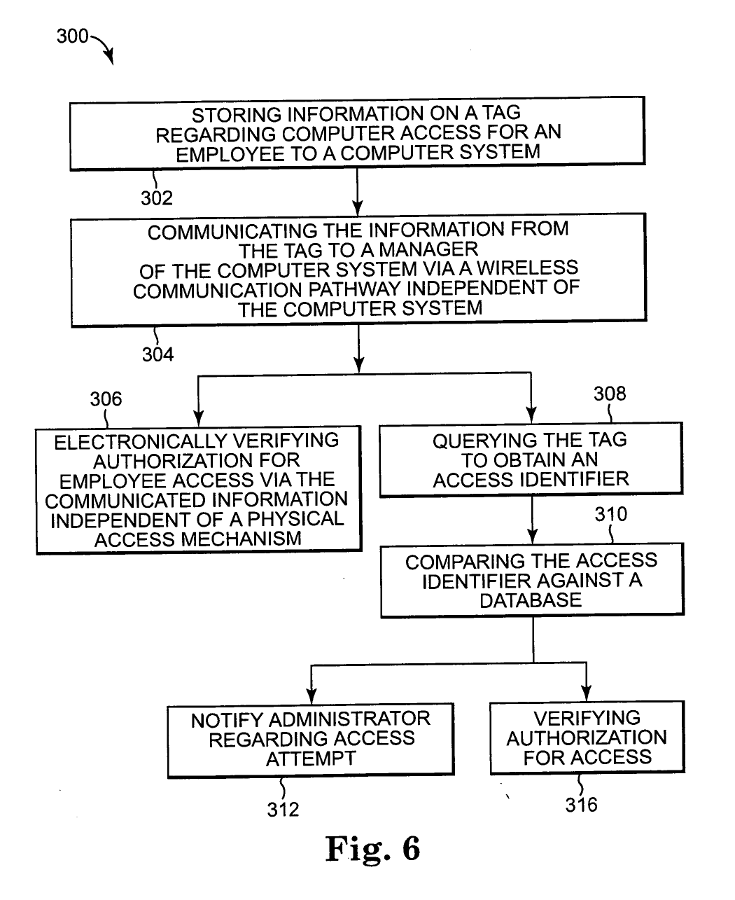

As shown in FIG. 3, access area 102 defines an area in which RFID transponder tag 105 is in close enough proximity to communicate wirelessly with an array 120 of computers (or computer resources) 122-128 via their transceivers 150. Manager 140 comprises a network type manager for monitoring and controlling access to computers 122-128 of computer system 100, and is in wired communication with each of those computers 122-128. In one embodiment, access monitor 142 of manager 140 enables monitoring access of each component of computer system 100, and is further described and illustrated in association with FIG. 5.

RFID transponder tag 105 conveys information to manager 140 via transceiver 150 about an employee 104 or other individual(s) attempting to gain access to one of the computers 122-128 of computer system 100. The information is stored in a memory (e.g. memory 28 in FIG. 1-2) of RFID transponder tag 105 for transmission to transceiver(s) 150. If the information on RFID transponder tag 105 matches information within manager 140, access is granted to computer system 100. The type of information is described in more detail in association with FIGS. 3-6.

In one embodiment, each RFID transponder tag 105 comprises a passive transponder. In another embodiment, one or more RFID transponder tags 105 comprise an active transponder.

As shown in FIG. 3, transceiver 150 is disposed within or on each computer 122-128 of computer system 100 for wireless communication from each transceiver 150 with RFID transponder tag(s) 105. In one embodiment, transceiver 150 of each computer obtains its power from a source (e.g., an internal battery) different than components of computer system so that the independent communication pathway of RFID transponder tag(s) 105 and transceivers 150 of each computer enable access control monitoring of a computer system 100 even when an individual computer of computer system 100 is not powered up. In one embodiment, this feature enables manager 140 to verify authority to access an individual computer and prevent the computer from being power up if access is not authorized for that employee or user. In one aspect, manager 140 performs this verification by direct wireless communication between RFID transponder tag 105 and transceiver 150 of manager 140, rather then between RFID transponder tag 105 and a transceiver 150 of one or more computers 122-128 (which in turn would communicate via wired pathways with manager 140).

Accordingly, transceivers 150 and RFID transponder tag(s) 105 enable a wireless communication network that is transparent to the normal function and operation of components of the computer system yet which enables controlling access to the computer system in cooperation with a manager 140 of the computer system 100.

In one embodiment, computer system 100 includes only a single computer from array 120 with that computer including access monitor 142 for monitoring access to the single computer. The single computer still includes transceiver 150 for wireless communication with transponder tag 105 to enable controlling access to the single computer.

Login module 106 enables a user to identify themselves to computer system 100, such as through a user interface, while password function 108 enables the use of passwords to limit login access to only authorized individuals. However, in one embodiment, RFID transponder tag 105 stores in its memory the login information (e.g., user name) and password information so that the login and password functions are carried out wirelessly between RFID transponder tag 105 and manager 140 via transceiver 150, rather than through conventional keyboard or user interface entry. This feature eliminates the often monotonous keyed entry of login and password information.

Wireless communication between RFID transponder tag 105 and transceiver 150 is distant dependent. Accordingly, when an employee with RFID transponder tag 105 moves out of range of communication with transceiver 150, wireless communication ceases and access to computer system 100 is terminated. In one embodiment, the signal range between RFID transponder tag 105 and transceiver 150 is set via manager 140 to correspond to a predetermined physical distance between the employee and one or more of computers 122-128. Accordingly, as long as the employee with RFID transponder tag 105 is within that physical distance relative to computers 122-128, access is maintained. However, when the employee with RFID transponder tag 105 exceeds that physical distance relative to computers 122-128, access is terminated. This feature insures that a computer will be protected from unauthorized users when the computer is left unattended by a departing employee having authorized access.

In another embodiment, access to the entire computer system 100 including every computer 122-128 is granted via wireless communication between RFID transponder tag 105 and only one of computers 122-128 or between RFID transponder tag 105 and manager 140, so that the employee is then free to use any computer 122-128 in computer system 100.

As shown in FIG. 3, in one embodiment, computer system 100 is in communication with external computer system 180, which includes manager 182, data module 184, and user interface 186. User interface 186 is configured to display and enable operation of manager 182 of external system 180 and/or of manager 106 of computer system 100. In one embodiment, manager 182 is configured to manage operations of a plurality of computer systems, including computer system 100, so that manager 182 acts as a central monitoring station of several computer systems, each of which have their own wireless monitoring mechanism.

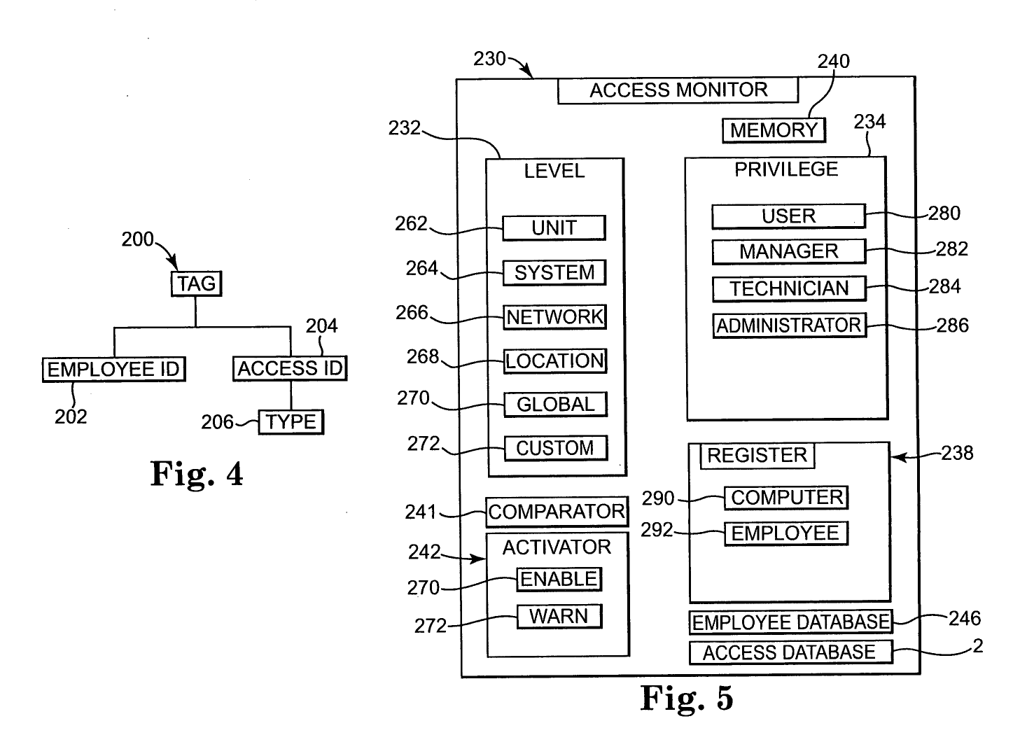

FIG. 4 is a schematic illustration of a RFID transponder tag, according to one embodiment of the invention. As shown in FIG. 4, RFID transponder tag 200 comprises employee identifier 202 and access identifier 204 with access type identifier 206. RFID transponder tag 200 has substantially the same features and attributes as RFID transponder tag 105 as previously described in association with FIGS. 1-3. Employee identifier 202 and access identifier 204 together specify information about an employee for evaluation by access monitor 142 to determine whether access to one or more computers 122-128 of computer system 100 will be granted. Various aspects of employee identifier 202 and access identifier 204 are described and illustrated in association with FIGS. 5-6. In one embodiment, employee identifier 202 comprises a personnel identifier for identifying an individual for which access can be granted, whether or not that individual is an employee. However, to gain access to a computer system, the individual will be listed within a database of personnel, such as an employee database or similar database available for confirming the identity of that individual.

FIG. 5 is a block diagram of access monitor 230, according to one embodiment of the invention. Access monitor 230 is configured to access to computer system 100, and has substantially the same features and attributes as access monitor 142 of manager 140 (FIG. 3), and additional features described herein.

As shown in FIG. 5, access monitor 230 comprises access level module 232, privileges module 234, register 238, memory 240, comparator 241, activator 242, employee database 246, and access database 248.

Level module 232 of access monitor 230 comprises one or more parameters that act to determine the level of access within computer system 100. In one embodiment, the level of access is based on the type of employee or person that is attempting access, with some types of individuals receiving limited access and other types of individuals receiving broader or unlimited access. In one embodiment, access level module 232 comprises unit parameter 262, local system parameter 264, network parameter 266, location parameter 268, global system/network parameter 270, and custom parameter 272. Unit parameter 262 specifies that the individual will get access only to a single computer or unit of computer resources, while local system parameter 264 specifies that the individual will get access to a local system of multiple computers. Network parameter 266 specifies that the individual will get access to an entire network of computers, including one or more local systems of computers. Global parameter 270 specifies that the individual will get access to a global group of computer networks while custom parameter 272 specifies that the individual will get access to a computer based on a custom level of access set by an administrator.

Privileges module 234 of access monitor 230 comprises one or more parameters that act to determine the type of privileges available when access is granted. In one embodiment, the type of privileges granted is based on the type of employee or person that is attempting access, with some types of individuals receiving limited access and other types of individuals receiving broader or unlimited access. In one embodiment, privileges module 234 comprises user parameter 280, manager parameter 282, technician parameter 284, and administrator parameter 286. User parameter 280 identifies an individual as a user with modest-privileges of using application programs, electronic mail, etc. Manager parameter 282 identifies individuals with user privileges and with broader privileges for monitoring users. Technician parameter 284 identifies individuals with special privileges unavailable to users and/or managers to enable the technician to perform maintenance and repair of computer system 100. Administrator parameter 286 identifies individuals with the broadest privileges for top level management of computer system 100, including monitoring the activities of all users, managers, technicians, and any other personnel with access privileges granted by the administrator.

Memory 240 comprises firmware, hardware, internal and/or external media devices used to store access monitor 230 and all of the values or settings of the parameters of access monitor 230.

In addition, the parameters of the level module 232 and the parameters of privileges module 234 can be used together to provide information about a user. In one embodiment, one parameter of privilege module 234 is linked to one or more parameters of level module 232. For example, a user is authorized access to a unit (via unit parameter 262) or system level (via system parameter 264) of access but not to a network level (via network parameter 266) or global level (via global parameter 270) of access. In another example, an administrator is granted access to all levels of access (e.g., unit, system, network, etc.). This linking feature enables access monitor to verify that a person (e.g., user, technician, administrator, etc.) should have access to the level of the computer system for which access is being attempted.

Register 238 tracks which employees (or other persons) have access to the computer system via wireless communication and which computers (or computer resources) are being accessed via wireless communication. In one embodiment, the employees (or other persons) with access are tracked via employee parameter 292 while the computers (or computer resources) accessed are tracked via computer parameter 290.

Employee database 246 comprises a database of all employees or other persons associated with an organization, including information about their role, if any, within the organization or relative to the computer system. In particular, each employee listed within employee database 246 carries an employee identifier 202 (or person identifier) that uniquely identifies that employee. In one embodiment, the employee identifier 202 is embodied electronically within RFID transponder tag 200, as previously described in association with FIG. 4.

Access database 246 comprises a database of which employees or other persons in employee database have authorization to access the computer system. In particular, each employee listed within employee database 246 carries an access identifier 204 that identifies a type of access (via privileges module 234) or level of access (via level module 232), if any, that is uniquely associated with the employee via employee identifier 202. In one embodiment, the access identifier 204 is embodied electronically within RFID transponder tag 200 as previously described in association with FIG. 4.

Comparator 240 performs a comparison of an employee identifier 202 and/or an access identifier 204 (FIG. 4) against employee database 246 and access database 248 to determine whether access will be granted and which type/level of access is to be granted. Activator 242 controls activation of access to computer system 100 based on the results of comparisons made by comparator 240 regarding an attempted access. In one embodiment, enable function 270 of activator 242 enables access or prevents access, respectively, based on the results of the comparison. If access is to be granted, then the type of access is set via privileges module 234 and the level of access is set via access level module 232.

Warn function 272 of activator 440 warns an administrator or employee (or other person) via manager 140 (FIG. 3) of an unsuccessful attempt to access the computer system via RFID transponder tag 105. Alternatively, warn function 272 can be replaced by an okay function which identifies that access should be granted.

FIG. 6 is a flow diagram of a method 300 of monitoring a computer system, according to one embodiment of the invention. In one embodiment, the systems described and illustrated in association with FIGS. 1-5 are used to perform method 300.

As shown in FIG. 6, at 302 method 300 comprises storing information on a RFID transponder tag regarding computer access for an employee to a computer system. At 304, the information is communicated from the RFID transponder tag to a manager of the computer system via a wireless communication pathway independent of the components of the computer system. In one embodiment, this wireless communication pathway is embodied in a RFID transceiver associated with the computer system and the RFID transponder tag associated with the employee. The wireless communication takes place between the RFID transceiver and the one or more RFID transponder tags (one for each employee or user) so that no wires, traces, pins or other portions of components of the computer system are used to enable this communication pathway for controlling access to the computer system.

In one embodiment, at 306 method 300 further comprises electronically verifying authorization for employee access to the computer system via the wirelessly communicated information. This electronic confirmation of authorization to access the computer system is independent of a physical access mechanism, such as conventional card readers and/or biometric devices. However, in one embodiment, a physical access mechanism is provided in addition to a wireless access of the present invention to further secure the computer system from unauthorized access.

In another embodiment, at 308 method 300 comprises querying the RFID transponder tag to obtain an access identifier and employee identifier associated with an employee. At 310, the access identifier of the RFID transponder tag is compared against an employee database and/or access database of information regarding the employee and access authorization for that employee. The database can be internal to computer system 100 within manager 140, or external to computer system 100, such as in database 184 of external system 180 (FIG. 3).

In one embodiment, at 312 an administrator is notified of an attempt to access the computer system based on the comparison at 310. The notice is provided when access fails and/or when access is successful.

In another embodiment, at 316 authorization for access is verified based on the comparison at 310.

Accordingly, a method of controlling access to a computer system via a wireless communication pathway enables electronic verification of authorization to access the computer system.

Embodiments of the invention greatly simplify the task of implementing an access control system into a computer system by effectively permitting the overlay of wireless communication mechanisms outside of the conventional functions, communication pathways, and connections/or of the computer system. Parameters of each employee (or other individual), which are stored in an identification tag or badge, are communicated to a manager of the computer system to enable determining whether access will be granted to the employee.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A workstation system comprising:
at least one workstation including a RFID transceiver; and
a RFID transponder tag including a memory for storing a personnel identifier and an access identifier; and
an access manager for controlling access to the at least one work station via wireless communication between the RFID transceiver and the RFID transponder regarding the access identifier and the personnel identifier.

2. The workstation system of claim 1 wherein the access identifier comprises an access type identifier.

3. The workstation system of claim 1 wherein the access manager comprises at least one of:
an access level module; and
an access privilege module;
an employee database; and
an access database.

4. The workstation system of claim 3 wherein the access level module comprises at least one of:
a unit parameter;
a system parameter;
a network parameter;
a location parameter;
a global parameter; and
a custom parameter.

5. The workstation system of claim 3 wherein the privilege monitor comprises at least one of:
a user parameter;
a manager parameter;
a technician parameter; and
an administrator parameter.

6. The workstation system of claim 1 wherein the access manager comprises:
a comparator module configured to determine access eligibility by comparing the access identifier and the personnel identifier of the RFID transponder tag with a predetermined criteria of the access manager; and
an activator module configured to control access to the workstation system via the RFID transponder tag based the access eligibility determined by the comparator module.

7. The workstation system of claim 6 wherein the activator module comprises an enable function to selectively enable access to the workstation.

8. The workstation system of claim 7 wherein the activator module comprises a warn function for producing a warning that the tag does not enable access to the workstation system.

9. The workstation system of claim 1 wherein the access manager comprises:
a register including a computer module and a personnel module, which in combination, enable tracking of computer access of personnel within the workstation system.

10. The workstation system of claim 1, and further comprising:
a second computer system, separate and external to the workstation system, in communication with the workstation system and configured to monitor access at the workstation system including a database of personnel information and access information to enable the access manager to control access to the workstation system.

11. The workstation system of claim 1 wherein the workstation system comprises a computer system and the at least one workstation comprises at least one computer.

12. The workstation system of claim 1 wherein the at least one workstation comprises at least one of a point-of-sale terminal and a machinery operating station.

13. A wireless monitor for a computer system, the monitor comprising:
means for assessing an access identifier and an employee identifier to determine access to a computer system; and
means for wirelessly communicating the access identifier and the employee identifier from an individual to the means for assessing.

14. The wireless monitor of claim 13 wherein the means for wirelessly communicating comprises:
a RFID transponder wearable by the individual and including a memory for storing the access identifier and the employee identifier; and
a RFID transceiver at the computer system and in wired communication with the means for assessing.

15. The wireless monitor of claim 13 wherein the means for assessing comprises a level module configured to determine a level of the computer system to which access is granted, the level including at least one of a unit, a system, a network, and a global system.

16. The wireless monitor of claim 13 wherein the means for assessing comprises a privilege module configured to determine a type of person to which access is granted, the type including at least one of a user, a manager, a technician, and an administrator.

17. A method of monitoring a computer system, the method comprising:
storing access information on a RFID transponder tag regarding computer access to a computer system, the information including a personnel identifier and an access identifier; and
communicating the access information from RFID transponder tag to a manager of the computer system via a wireless communication pathway between the RFID transponder tag and the RFID transceiver.

18. The method of claim 17 wherein storing information comprises storing a privilege identifier configured to determine a type of access, the type including at least one of a user, a technician, and an administrator.

19. The method of claim 17 wherein storing information comprises storing a level identifier configured to determine a level of access, the level including at least one of a unit, a local system, a network, and a global system.

20. The method of claim 17 wherein communicating the information comprises automatically logging an individual into the computer system via the personnel identifier and the access identifier wherein the personnel identifier uniquely identifies the individual and the access identifier includes a password unique to that individual.

21. The method of claim 17 and further comprising:
preventing access to the computer system when the RFID transponder tag is located a distance from the RFID transceiver that exceeds a signal range between the RFID transponder tag and the RFID transceiver.

22. The method of claim 17 wherein communicating the information comprises:
electronically verifying authorization for access via the communicated information independent of a physical access mechanism.

23. The method of claim 17 wherein communicating the information comprises:
querying the RFID transponder tag to obtain the access identifier; and
comparing the access identifier against a database of component information including at least one of:
verifying authorization for access; and
notifying an administrator regarding attempted access to the computer system.

24. The method of claim 17 wherein communicating the access information comprises:
disposing the RFID transceiver in an access manager separate from the at least one computer.

25. The method of claim 17 wherein communicating the access information comprises:
disposing the RFID transceiver in the at least one computer and arranging the access manager to be located external to the at least one computer with the access manager in wired communication with the at least one computer.

26. A computer network comprising:
a plurality of computers;
at least one RFID transceiver associated with the plurality of computers and in wired communication with the plurality of computers;
at least one RFID transponder tag configured for wireless communication with the at least one RFID transceiver, each at least one RFID transponder tag including a memory for storing an access identifier and an employee identifier; and
a manager in communication with the at least one RFID transceiver and including an access monitor configured to control access to each computer of the plurality of computers via communication between the at least one RFID transceiver and the at least one RFID transponder tag regarding the access identifier and the employee identifier.

27. The computer network of claim 26 wherein the at least one RFID transceiver comprises a plurality of RFID transceiver with each RFID transceiver being disposed at each computer of the plurality of computers.

28. The server system of claim 26 wherein the at least one RFID transponder tag comprises a plurality of RFID transponder tags, wherein the employee identifier uniquely identifies one specific employee and the access identifier uniquely identifies access credentials unique to that one specific employee.
